(19) United States
(12) Patent Application Publication
(10) Pub. No.: US 2008/0197222 A1
(43) Pub. Date: Aug. 21, 2008

(54) Flexible and sealed apparatus for disposing of fluorescent lamp tubes and other mercury containing bulbs

(76) Inventor: Peter A. Barton, Burien, WA (US)

Correspondence Address: Peter A. Barton, 16415 29th Place SW, Burien, WA, 98166-3101, US

(21) Appl. No.: 11/708,227

(22) Filed: Feb. 20, 2007

(51) Int. Cl. B02C 23/00

(52) U.S. Cl. 241/99

(57) ABSTRACT

A reclamation system for breaking, consolidating, and shipping used fluorescent lamp tubes comprising a breaking chamber consisting of a flexible portion or tube where multiple lamp tubes are broken by being struck with a mallet. The breaking chamber is then ready to be packed and sent to a recycling depot. In another embodiment, the broken tubes are dumped directly from the breaking chamber into a receiving drum. When the drum is full, the breaking chamber is folded back and forth on itself and stored on the lid of the receiving drum. This seals the drum, without being opened in the field. A protective cap is then attached and the filled drum along with the breaking chamber is shipped to a recycling depot where it is emptied, cleaned, re-furbished, and returned to the field ready to receive another load of fluorescent tubes.

In both embodiments, the vapors and dust are within a sealed apparatus from the time of loading with whole tubes to the opening at the recycling depot.

Incandescent lamps may be mixed in the waste stream along with fluorescent lamp tubes because both are made of the same metallic and glass components.

The system may be used for packing and shipment of other hazardous materials in powdered or slurry forms.

### BACKGROUND OF THE INVENTION

1. Field of the Invention

Disposal of mercury containing lamps by, breaking, consolidation, and shipping without releasing mercury vapor and/or phosphor dust.

2. Background and Description of Related Art

Fluorescent lamp tubes contain a dangerous mercury vapor and a mix of exotic and common metals in a powdered phosphorescent coating inside a glass tube. The electrodes are tungsten, and the end caps are aluminum, both are highly desirable to be reclaimed.

In the United States, the recycling rate for fluorescent tubes is 20% and steady. In Europe, the recycling rate is 80%. The present invention is intended to make recycling of fluorescent lamp tubes easier, safer, and to raise the rate of recycling.

Modern 4 foot T12 tubes (2006) have 12 mg of mercury, older ones may have as much as 46 mg of mercury plus argon or neon. The phosphor in a common “cool white” lamp is a complex mixture containing Europium, cerium, lanthanum, terbium, and yttrium metals. Halo phosphate phosphors contain calcium, phosphorus, chlorine, fluorine, antimony, and manganese. Some of these are rare, and none should be released into the environment.

During the working life of a fluorescent lamp the mercury is gradually absorbed into the phosphor. At the end of lamp's useful life, where the light output is waning, and the lamp flickering, up to 98% of the mercury has been absorbed, so it is not available to take part in the intended operation of the lamp. However, that makes the phosphorescent powder even more dangerous, and demands that it be contained.

Since most large users of fluorescent lighting re-lamp on a schedule before the end of life, there is still considerable mercury vapor in the tubes.

The current practice of recycling spent lamp tubes using fiber packing tubes and corrugated boxes is fraught with issues. The most egregious is how often unsuspecting workers are exposed to varying levels of mercury and complex metal containing chemical phosphor compounds during the cradle to grave life cycle of this practice. Outbound shipping is expensive because the dimension of a fiber tube exceeds UPS standards. On site generator storage of empty and full fiber tubes is awkward. The packing tubes must not get wet or the packaging integrity is lost. These relatively light products have a tendency to tip or blow over (particularly 8 footers) and implode, creasing the fiber tube and again compromising the packaging integrity. Recyclers' reports 5 to 8% of the bulbs arrive at their facility already broken. Any recycled fiber tube will have a layer of phosphor dust readily visible on the inside walls, a good sign for the presence of mercury. When retired, the boxes and fiber tubes go to a paper mill to be recycled where the residual mercury and phosphor compound is again released back to the environment or incorporated in new paper products being sold to the public.

The industrial market also uses Drum Top Crushers to dispose of spent lamps. A drum top crusher rests on a 55 gallon drum and incorporates a motor with a flail to break the tube as it falls under gravity into the drum. The glass is collected in the drum and vapors within the vessel are exhausted through a filter.

Though these drum top crushing systems appear simple they too emit untold amounts of mercury. There are many components to a drum top crusher and all must fit tightly and be properly maintained to minimize release. As these components are removed through normal operation, small but visible quantities of phosphor are invariably released. In reality gaskets fail or are lost, parts fit poorly, filters and filter controls are overridden, and machines receive poor maintenance. The drum top crusher is generally operated by a low paid and untrained laborer of the work force. The crusher must be removed during each drum change, adding further exposure of the unsuspecting worker to the real danger of concentrated levels of mercury in a confined place. A similar, more concentrated release can occur when the drum is opened at the recycling depot.

It is estimated that much of the crushed glass is disposed in land fills and not recycled, based on the low volume of crushed glass received by the recyclers. Of potentially even more concern is the possibility of improper disposal of the mercury contaminated and concentrated filters. Since a drum holds approximately 800 consolidated T12 lamps at about 46 mg each, almost 36 grams of mercury per drum would be sent to the landfill.

A drum top crusher can compact fluorescent tubes at about a 12 to 1 compaction. About 800 T12 tube or 600 pounds will fit in a drum, thus replacing at least 13 sixty six tube cardboard shipping tubes presently used.

Typical drum top crushers are described in U.S. Pat. No. 7,1,056 by Edward Domanico, (October 2006), U.S. Pat. No. 5,899,395 by Joseph Deklerow, (May 1999), U.S. Pat. No. 5,575,429 by Deklerow's associate Otto Muller-Girard, U.S. Pat. Nos. 5,205,497 and 4,655,404 both by Joseph Deklerow, (April 1987). All are similar in that they are an assembly with a ridged tube for receiving a fluorescent lamp leading to a breaker device, such as a whirling flail or blade inside the drum, which violently breaks the fluorescent lamp into small pieces and deposits the fragments into a drum or flask. However, they all also require the fragmentation assembly to be removed to permit closing and sealing the drum for shipment to a reclaiming depot. During the closing operation, the drum contents are exposed to the environment letting mercury vapor and phosphor dust escape. The EPA has declared this to be inadequate, and has discouraged the use of such devices through regulation.

Furthermore, when the prior art fragmentation assembly is being stored by the waste generator between disposal sessions. The storage shelf and surrounding environment is exposed to mercury vapor, phosphor dust, and tiny shards of contaminated glass.

The present invention uses a gentler system to break the lamp tubes and never opens the vessel to the environment. Furthermore, no contaminated breaker units are exposed or stored on the premises.

At the reclamation center, the drum and breaking chamber are cleaned and refurbished for shipment back to a tube user for disposal of his retired fluorescent tubes.

3. Objects of the Invention

It is an object of the invention to have a fluorescent lamp tube crushing chamber that remains tightly sealed against release of mercury vapor or phosphor dust during the crushing operation, closing, and subsequent shipping.

It is another object of the invention that the bulk volume of disposed fluorescent tubes be reduced by crushing, thereby consolidating the tube components by a ratio of approximately 12 to 1 thereby making the mass ship able by UPS or similar.

It is another object of the invention that the crushed tubes be shipped in the crushing chamber sealed to avoid hazardous release.

It is another object of the invention that, after emptying, the system be cleaned, refurbished, and returned to the users of fluorescent lamp tubes for re-use.

It is another object of the invention that the components have long life, and able to withstand the repeated rigors of transportation and rough handling.

It is another object of the invention to eliminate the use of oversize cardboard tubular containers to transport used tubes, and to prevent accidental breakage and subsequent release of mercury and chemicals.

It is another object of the invention to accomplish the above objects and more by using a tough closable, cleanable, reusable flexible tube as a crushing chamber.

It is another object of the invention to provide a crushing system that can accommodate tubes of any length and others having bulky configurations such as U shaped circle, and compact fluorescents and high intensity discharge (HID) bulbs.

It is another object of the invention to attach a steel drum to the crushing chamber for receiving crushed tubes. The drum and crushing chamber attachment being inseparable by the lamp user.

The description of the invention following, along with the accompanying drawings will describe a device meeting and exceeding the above objects.

4. Definitions

Wording used to describe elements of the present invention should be given generous scope.

Barrel, Cask, Drum, and Bucket are synonymous, except where context clearly separates the meanings.

Crushing chamber, Crushing tube, are synonymous and are the place where fragmentation takes place in the present invention.

Proximal end, the end of closest to the operator. The near end. The loading end of the crushing chamber.

Distal end, The end farthest from the operator. The far end. The end of the crushing chamber opposite the loading end.

Generator, the place, person, or organization generating a waste stream of recyclable material. A lamp replacement activity.

### BRIEF SUMMARY OF THE INVENTION

The invention described herein is a system for safely, and environmentally sound disposal of fluorescent tubes and other lamps containing mercury and other hazardous materials, and the recovery of the component materials of a fluorescent lamp.

The present invention operates in the portion of the reclamation cycle beginning with receiving used fluorescent lamp tubes at the place where they have been removed from service or at collection depots. Typical sources of used tubes are office buildings, schools, malls, mega-stores, factories, collection depots, Household Hazardous Waste facilities, etc.

In one embodiment the crushing chamber is open only on the in-feed end. Whole tubes including U-shaped, CFL's, and HID's are loaded inside. Once full, the chamber is closed and sealed via a closure that can not be reopened by the loader. The glass is then broken by striking the flexible chamber with a blunt object. The chamber with the crushed glass inside is then lowered into its original box, folded and sealed for prepaid shipment to the recycler.

A second embodiment is a new type of drum top crusher that is never opened by the generator. In this embodiment, the far end of the crushing chamber is attached to a custom designed steel drum top adapter. The drum top adapter attaches to the top of a user supplied 55 gallon drum using standard bolt ring technology. The crushing chamber is approximately 9 feet long (to accommodate 8 foot tubes) and attaches to a flanged hole on the drum top adapter.

The operator pushes whole, straight tubes into the crushing chamber through a one way valve with a gasket seal. When the chamber is filled with many lamp tubes, the operator strikes the chamber with a blunt object to pulverize the glass. The tubes, regardless of length, are fully encapsulated prior to crushing. The chamber is then lifted, shaking the glass shards into the drum. The process is repeated until the drum is full. The crushing chamber is then folded inside the drum top adaptor and is capped off with a protective steel drum cover for shipment to a licensed tube recycler. The assembly and attached 55 gallon drum is DOT approved for solids.

The recycler removes the glass from either the drum assembly or collapsed crushing chamber in his controlled facility and processes the contents accordingly. The lamp recycler is responsible for decontaminating, refurbishing, and recertifying the system for reuse time and time again.

In both embodiments an activated carbon breather is incorporated to accommodate any negative or positive pressure within the system. Any air expelled from the chamber passes safely through the activated carbon. At no point in the process can the operator come in contact with the contents inside the crushing chamber or drum. Testing has shown a 12 to 1 volume reduction. A 55 gallon drum will hold about 800 4 foot T12's which is roughly the volume of a 13 4 foot fiber tube which hold approximately 66 lamps each.

There are no motor driven flails or blades to create dust and tiny glass shards. No connection to electrical power is needed.

### BRIEF DESCRIPTION OF THE FIGURES

FIG. 1 is an illustration of the minimal system without the receiving drum.

FIG. 2 is an end view of the self-gasketing “trap door” through which lamps are inserted.

FIG. 3 is a cut-away view of the apparatus packed for shipping.

FIG. 4 is a cut-away view showing a vapor purging subassembly.

FIG. 5 is an overall view of a drum top tube buster ready to receive discard fluorescent lamps.

FIG. 6 is an alternate embodiment of the “trap door”

FIG. 7 is an alternate embodiment for the down-tube of the vapor purging subassembly

FIG. 8 is an alternate embodiment of the protective shipping cap subassembly

FIG. 9 is a cut-away side view of the trap door of FIG. 6

TABLE OF IDENTIFIED DETAILS

| | |
|---|---|
| 1. | The tube buster apparatus |
| 2. | The lamp crushing chamber (busting tube, crushing tube) |
| 3. | Receiving drum |
| 4. | Modified drum lid |
| 5. | Trap door assembly to seal the entrance |
| 6. | Iris or finger closers |
| 7. | Mounting ring |
| 8. | Busting tube attachment to lid |
| 9. | Breathing vent assembly containing an activated carbon |
| | filter |
| 10. | |
| 11 | Threaded port for purging the drum air |
| 12. | Folded busting tube |
| 13. | Lid attachment clamping ring |
| 14. | Cap assembly |
| 15. | Cap lid portion |
| 16. | Cap barrel portion |
| 17. | Down tube or drop tube for purge air |
| 18. | |
| 19. | Threaded insert adapted to go into 11 |
| 20. | Air vent holes |
| 21. | Driving point (well point) |
| 22. | End cap for the minimal system |
| 23. | Receiving end of minimal system |
| 24. | Filtered vent |
| 25. | Ring clamp with bib for closing cap barrel cut-out |
| 26. | Bib or cover for closing cap barrel cutout |
| 27. | Ring clamp tightening tabs |
| 28. | Flapper type one way valve, spring loaded |
| 29. | Rubber gasket seal |
| 30. | Hinge line |
| 31. | Drum extender |
| 32. | Opening for tube 2 |
| 33. | Fluorescent tube guide nozzle |

### DETAILED DESCRIPTION OF THE INVENTION

Two models of the crushing and shipping apparatus are described.

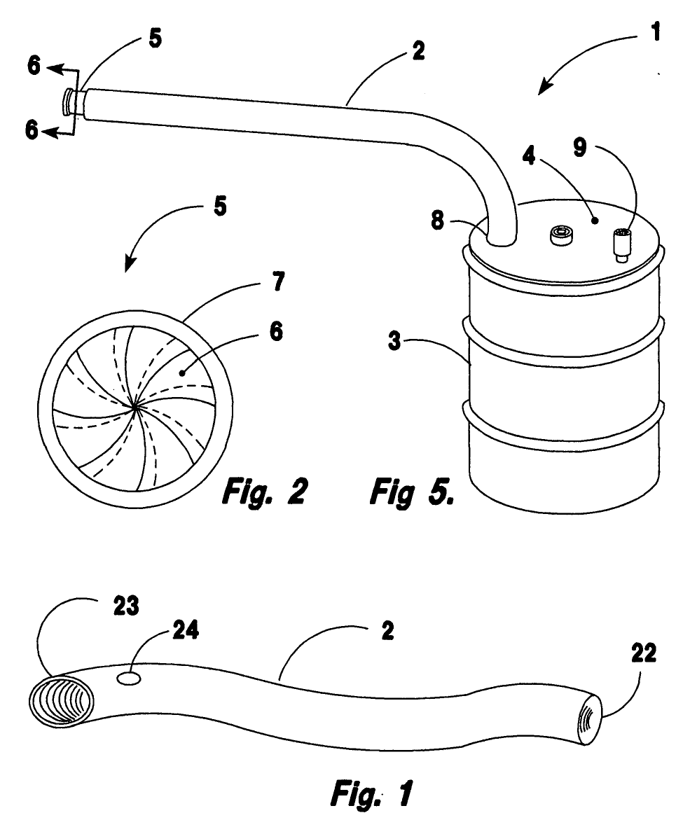

FIG. 1 shows a minimal apparatus comprising the crushing chamber 2 without a shard receiving drum. In the preferred embodiment the distal end is sealed permanently with a disk of the tube fabric. The proximal end is open for receiving the tubes. A filtered vent 24 is attached to the tube wall. When the crushing chamber, has been filled with unbroken tubes, the open end is sealed by rolling the end and locking with a buckle that requires special tools to open. The contents are then broken by striking the exterior of the crushing chamber with a mallet. Obviously, the force of the blows is transferred to the lamp tubes causing them to break. The shock of the vacuum suddenly being “released” causes most of the un-struck portions to fracture. A few more blows may be necessary to break the remaining tube fragments. The crushing chamber is then rolled or folded and packed singly or in multiples into a shipping container which will be an appropriate shipping drum, barrel, bucket, or box. In the preferred embodiment, the shipping container is the same box in which the tube crushing apparatus arrived at the re-lamping site.

Alternatively, either or both ends may be closed and sealed by a clamp, or the distal end may be sealed by flattening and welding.

The capacity of the minimal apparatus should be about 66 tubes, similar to the capacity of the former cardboard tubes, but reduced to a very much smaller volume.

At the recycling depot, the crushing chamber is purged through vents at each at each end. It is preferred that the purging be done under internal negative pressure (or external positive pressure). This will draw the flexible wall down snugly onto the contained glass and force the purging air to flow through the glass mass instead of around the mass.

The tube crushing, collection, and shipping apparatus shown in FIG. 5 is identified generally by the numeral 1 and associated pointing arrow. After crushing the lamps within the crushing chamber 2, the proximal end of the crushing chamber tube is lifted, the fragmented contents are emptied into drum 3 through lid opening 8, to which the distal end of the tube is fixedly attached.

Referring to FIG. 1 or 5, the crushing chamber 2, is fabricated of tough, air tight, re-enforced vinyl sheeting. Adequate sheeting material is manufactured by Cooley Group, Pawtucket R.I. as product XR5. The flexible tubular crushing chamber typically has a circumference of 19 to 34 inches, (equivalent to 6 to 10 inches diameter). Larger or smaller circumferences are within the scope of this disclosure. A tube with single lamp capacity would have a circumference of about 6 inches.

Referring to FIGS. 5, 6, and 9, the proximal end of the crushing chamber tube is fitted with a trap door assembly 5; preferably a spring loaded metal swinging door as shown in FIGS. 6 and 9 (section 6-6, and 9-9) Door 28 swings on hinge 30, and closes against a rubber gasket 29. This seals the tube against gasses escaping during the crushing operation, when not in use, and during shipping, yet the door is easily opened to pass whole fluorescent tubes. The trap door does not have to be round in shape.

An alternative embodiment is shown in FIG. 2. A rubber iris or finger structure 6 fixedly attached to a mounting ring 7. The resilient fingers will permit one or more lamp tubes to pass while the resiliency of the fingers maintain a fair seal against the sides of the glass lamp tubes.

The drum lid 4 is fitted with a breathing vent 9 which contains an activated carbon filter adapted to adsorb mercury vapors. This vent continuously operates both in and out to equalize internal and external pressures. Activated carbon specially prepared to adsorb mercury is widely available, in particular from PICA U.S.A.

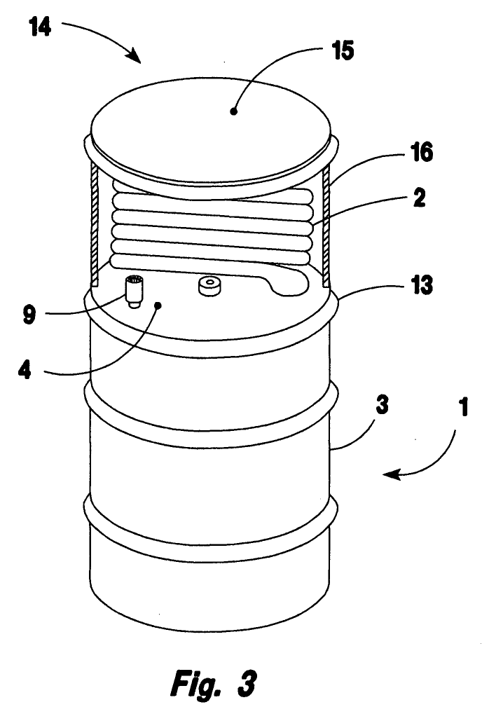

When the drum is full, the assembly is made ready for transport to the reclamation center, the breaking chamber tube 2 is folded as shown in the cut-away view of FIG. 3. The multiple folding closes the loading hole 8. The drum can breathe to equalize internal and external air pressures through the activated charcoal containing vent 9. The folded tube is then covered by a protective cap assembly 14, and is ready for transport to the recycling center.

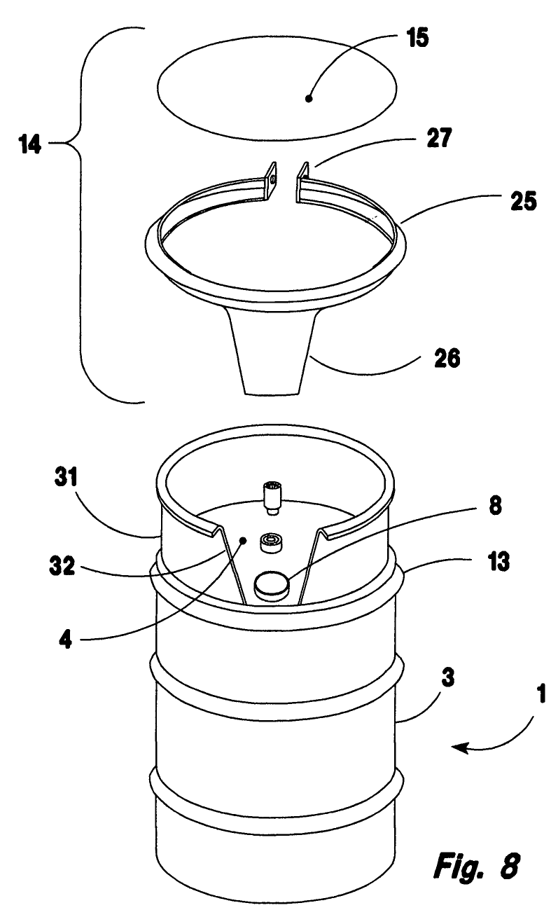

FIGS. 3 and 8 illustrate two embodiments of the protective cap 14. The cap in FIG. 3 is a cup-like assembly consisting of a tube 16 and lid 15. The cap is irremovably attached to drum lid 4 by any convenient means such as bolting, L slots, or a clamping ring commonly used to secure drum lids. The FIG. 3 configuration may be constructed in one piece by deep drawing, welding, riveting, or like the bottom half of a steel drum, or in two pieces using a drum style clamping ring to join a tube and flat lid.

The cap shown in FIG. 8 is a portion of a tube 31 welded to drum lid 4 and having a cut out 32 for passage of the crushing chamber tube 2. The design of clamping ring 25 is based on an ordinary drum clamping ring, but has a bib 26 fixedly attached which closes the cutout 32 and holds lid piece 15 securely in place on top of the whole assembly.

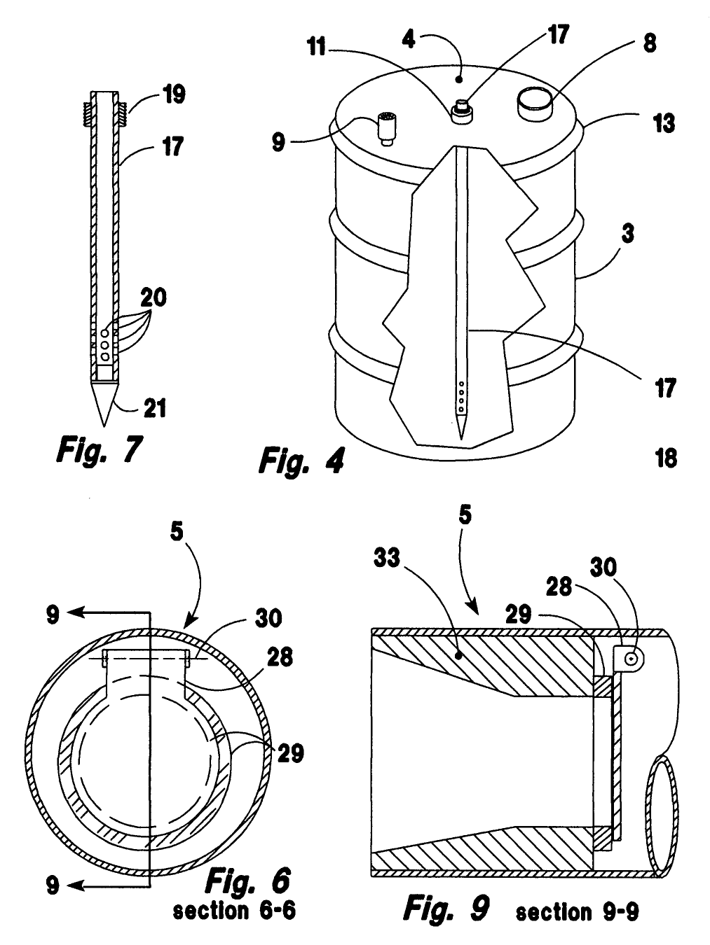

FIGS. 4 and 7 illustrate a purging means for removing mercury vapor and evaporating adsorbed vapor from the glass, phosphor, and drum walls. This step is to be done at the recycling center prior to opening the drums for dumping into the classifier machine.

A tube 17 extends through lid 4 to the bottom of the drum 3. During filling and shipping, the purging port 11 in lid 4 is closed with a plug designed to be resistant to being opened by the tube crushing crew. A plug requiring a large size Allen wrench will be satisfactory. Large Allen wrenches are not common in most workplaces, and there is no particular incentive for the crew to open the port anyway. At the recycling center, the plug at purging port 11 is removed and tube 17 is driven to nearly the bottom of the drum. A suction or pressure is connected and air is passed through the entire mass of glass shards, mercury vapor laden air is withdrawn and is passed through a mercury absorbing filter. Mercury is volatile, so much of the mercury adsorbed on the glass, in the phosphor, and the drum wall will evaporate. The purging operation may be done overnight to take advantage of otherwise idle hours. The purge cycle may be closed by returning the air from the filter to the other drum port. A large separate in-line mercury filter will reduce the work load on the smaller drum vent filter 9, so will reversing the flow, where the flow through 9 is clean air. Warming the purging air should increase the amount of mercury recovered, so should purging at reduced pressure in the drum, or both. Mercury, like water, evaporates more easily in a warmed and/or low pressure atmosphere.

The purging tube assembly is detailed in FIG. 7. A sturdy tube 17 is fitted with a thread means 19 adapted to be received by vent port 11, a hard point 21 like a well driving point is attached to the far end of 17 along with exit vents 20. When port 11 is opened, the tube of FIG. 7 is driven through the mass of fluorescent tube fragments and screwed into port 11. Alternatives to a point could be a drill, auger, or similar.

Tube 17 as shown in FIG. 7 may be installed prior to filling the drum, or a tube like 17 may be fixedly attached to the underside of lid 4.

Alternatively, tube 17 may be omitted and the air through the purging ports exhaust only the ullage space, which is expected be saturated with mercury vapor as it has been undisturbed during shipping and other idle times. Purging only the ullage space is better than no purging, but does eliminate a major release of mercury vapor and possibly contaminated phosphor dust at drum opening time.

The purging means described and shown in FIGS. 4 and 7 can be adapted as an improvement to other designs for drum top fluorescent tube crushing. In particular, those described in the prior art section of this disclosure, and to similar drum top crushers.

### Alternative Embodiments and Variations of the Invention

The materials and sizes presented in the description of the tube crushing apparatus are illustrative only. The drum may be constructed of material other than steel, such a plastic, fibrous material, laminate, composite, etc. The drum portion may be any convenient size or shape such as pony drums, five gallon buckets, flasks, custom shapes and sizes, etc.

The crushing chamber and its entrance valve may be sized and shaped to receive items other than long tubes for fragmentation, such as U and ring fluorescent tubes, spiral lamps, Mercury, sodium, and multi-metal lamp ampoules, medical and specialty lamps, etc.

While disposing of mercury containing lamps is the intended primary purpose of the invented apparatus, other hazardous and non-hazardous items may be crushed, packed, and safely shipped to reclamation depots. Such items may include chemical glassware and bottles, new and used medical bottles and waste, dry chemicals, low level radio active waste, etc.

Conventional incandescent lamps have the same elemental materials as fluorescent bulbs, namely glass, tungsten, aluminum, and a small quantity of lead solder. Thus they can be processed through the recycling system right along with fluorescent tubes.

A mallet provides a simple and economical means to crush discarded fluorescent lamps, however, any other means such as jaws, stampers, rollers, etc. may be used without compromising the function, intent, or scope of the invention.

FIG. 3 depicts the crushing chamber 2 as being folded zig-zag for shipment. Other folding forms or rolling are acceptable as without compromising the function, intent, or scope of the invention.

### How to Use the Invention

To use the first embodiment of the invention, the crushing tube is loaded with whole tubes, sealed, struck with a mallet or similar, shaken down to the far end, folded, and packed into a shipping container.

To use the second embodiment of the invention, the apparatus is prepared for receiving used fluorescent tubes. The protective cap is removed and the crushing tube stretched out on the floor, or preferably, on a table or raised plank of suitable height. As many lamp tubes as the crushing tube will hold are inserted.

The stack of lamps is then struck with a mallet. The shock of the tube's vacuum shatters most of the un-struck sections of the lamps. More blows may be administered if desired to further fragment the glass. The entrance end of the crushing tube is then lifted and the fragmented glass and other lamp parts are dumped into the drum.

When the drum is full, the crushing tube is folded and replaced on the lid of the drum. The protective shipping cap is secured to the drum and the drum is shipped to a reclamation depot capable of handling such material.

Another way to prepare the crushing tube to receive lamps is to place the drum on the ground at a loading dock, and stretch the crushing tube out over the loading dock. Since most loading docks are at least partially outside the warehouse, accidental vapor release from a dropped lamp is quickly dissipated into the outdoor atmosphere, thus protecting the workers.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

I claim:

1. An apparatus for crushing and packing fluorescent lamps and the like for shipment to a recycling center comprising:
a. an elongated, air impervious, flexible tube having an open proximal end adapted to receive glass tubes and a distal end adapted for attaching a capping means, and
c. a capping means operabably attached to said distal end for closing and sealing said distal end, and
d. a closing and locking means for closing, sealing and locking said proximal end, said closing means further comprising a locking means requiring a tool to unlock for preventing the sealed proximal end from unauthorized re-opening, and
e. a forcing means to apply force to the exterior of said flexible tube wall, said force being transferred through the flexible tube wall to received glass tubes, thereby breaking said glass tubes into fragments, and
f. whereby when said glass tubes having been fragmented, said flexible tube is manipulated to move said fragments toward said capping means, thereby consolidating the tube fragments into a loose mass.

2. The apparatus of claim 1 where the capping means at the distal end of said elongated flexible tube is a fixedly attached cap.

3. The apparatus of claim 1 where the capping means at the distal end of said elongated flexible tube is a clamp attached to and holding the distal end closed.

4. The apparatus of claim 1 where the capping means at the distal end of said elongated flexible tube is a receiving receptacle having an attached lid with an aperture adapted for attaching said elongated tube, and where said aperture admits said glass fragments through, thence into said receiving receptacle.

5. The apparatus of claim 4 where said lid further comprising first and second purging ports passing through said lid for admitting air to clear contaminated air from the interior of said receiving receptacle.

6. The apparatus of claim 5 further having a removable tube extending through one purging port to the vicinity of the bottom of said receiving receptacle, thereby providing a conduit for air to pass through the mass of fragmented glass, whereby the interstitial air within the glass mass is removed and replaced by clean air.

7. The apparatus of claim 4 further comprising a protective cap covering the elongated flexible tube, said cap adapted to provide restraint of said tube and to provide protection against damage during shipping of the apparatus.

8. A method of crushing glass tubes containing mercury within an elongated sealable, likable, flexible tube and making ready for shipment to a recycling facility comprising:
a. inserting mercury containing glass tubes into said flexible tube until filled;
b. closing and sealing said flexible tube;
c. locking said flexible tube, thereby ensuring that said seal remains intact;
d. crushing said glass tubes by applying forceful energy to the exterior of said flexible tube;
e. packing at least one sealed and locked flexible tube containing crushed tubes contaminated with mercury in a shipping container adapted to receive said flexible tubes having mercury content.

9. An air purging means for a drum top fluorescent tube crusher comprising:
a. a receptacle adapted to receive crushed fluorescent tubes, said receptacle having a closing means adapted for preventing vapors and dust of crushed florescent tubes from escaping the receptacle, and
b. entrance and exit air ports communicating between the interior and exterior of the receptacle, and
c. a source of air connected to the entrance air port, where air enters said entrance port and exits said exit port, and
d. a filter operatively connected to said exit air port and adapted to remove mercury vapor and dust entrained in said exiting air, and
e. whereby, air is admitted into said receptacle through said entrance port causing contaminated air to be expelled through said exit port, thence through said filter where contaminates originally contained within said receptacle are removed from said receptacle and entrapped by said filter.

10. The air purging means of claim 9 where an air conduit is interposed between said exit air port and said filter.

11. The air purging means of claim 9 where said receptacle is substantially filled with crushed fluorescent tubes, and said closing means is a lid covering and sealing the top of the receptacle and having said entrance air port attached, and said lid further comprising an air conduit attached to said entrance air port and extending to the vicinity of the bottom of said receptacle, and a supply of air connected to said entrance air port whereby air is conducted through said air conduit to near the bottom of the bulk of crushed fluorescent tubes, thence urged upward through the interstitial spaces between said crushed tube fragments, thereby displacing contaminated air and causing contaminated air to exit said receptacle through said exit air port.

12. The air purging means of claim 9 where said receptacle is substantially filled with crushed fluorescent tubes, and said closing means is a lid covering and sealing the top of the receptacle and having said exit air port attached, and said lid further comprising an air conduit attached to said exit air port and extending to the vicinity of the bottom of said receptacle, and a supply of air connected to said entrance air port, whereby, air is urged downward through the interstitial spaces between said crushed tube fragments to the bottom of bulk of said tube fragments, thereby displacing contaminated air and causing contaminated air to enter the bottom end of said air conduit, thence exit said receptacle through said exit air port.
